(19) United States
(12) Patent Application Publication
(10) Pub. No.: US 2017/0278143 A1
(43) Pub. Date: Sep. 28, 2017

(54) METHOD FOR CREATING ADVANTAGEOUS LEVERAGE IN SPONSORSHIP OF CONTENT AND FINANCING OF MEDIA

(71) Applicant: Bernard Urban, New York, NY (US)

(72) Inventor: Bernard Urban, New York, NY (US)

(21) Appl. No.: 15/340,101

(22) Filed: Nov. 1, 2016

Related U.S. Application Data
(60) Provisional application No. 62/249,439, filed on Nov. 2, 2015.

(51) Int. Cl. G06Q 30/02; G06Q 50/18; G06Q 40/06

(52) U.S. Cl. CPC G06Q 30/0273; G06Q 40/06; G06Q 50/18

(57) ABSTRACT

The present invention is directed to a system and method for formulating and/or implementing sponsorship of an event or a facility. In the present invention multiple parties, including a content producer, a brand investor, and a fund holder, establish a relationship which includes transactions among them and between one or more of them and a lending provider. These transactions can be implemented automatically based on the relationship established among them, including for example, movement of money and facilities.

This application claims priority to U.S. Provisional Patent Application No. 62/249,439, filed Nov. 2, 2015, now pending, and incorporated by reference.

### BACKGROUND OF THE PRESENT INVENTION

In the past, sponsorship of events, such as sporting events, was rather simplistic. A brand wishing to sponsor an event, such as a conceit, would negotiate a sponsorship agreement in which a fee was paid, typically in advance, in exchange for certain naming rights or other benefits. This transaction did not involve any debt financing and could not be considered any form of capital investment. These types of transactions were therefore limited by the ability of the sponsor to pay with on-hand funds. While some sponsorships, such as stadium naming sponsorships, might be payable over time and the sponsorship might extend for that time period or longer, it still involved direct payment from the brand without good reason to obtain benefit of debt financing.

Consequently, there is a need for a new type of sponsorship model in which debt financing could be leveraged and the debt could be considered a capital investment by one of the parties to the transaction.

### SUMMARY OF THE INVENTION

The present invention is directed to a system and method for formulating and/or implementing sponsorship of an event, a series of events, or a facility, or some other form of sponsorship. In the present invention multiple parties, including a content producer, a brand investor, and a fund holder, establish a relationship among them which includes transactions among them and also between one or more of them and a lending provider. These transactions can be implemented automatically based on the relationship established among them, including for example, movement of money and facilities. The relationship with the lending provider preferably involves debt financing, which may have the benefit of conversion of capital for at least one of the participants.

### BRIEF DESCRIPTION OF THE FIGURES

FIG. 1 depicts a flow chart of money movement among participants in the present invention.

FIG. 2 depicts the flow chart of FIG. 1, inclusive of an agent.

FIG. 3 depicts an example flow in the present invention.

FIG. 4 depicts the steps of activity in the present invention.

### DETAILED DESCRIPTION OF THE PRESENT INVENTION

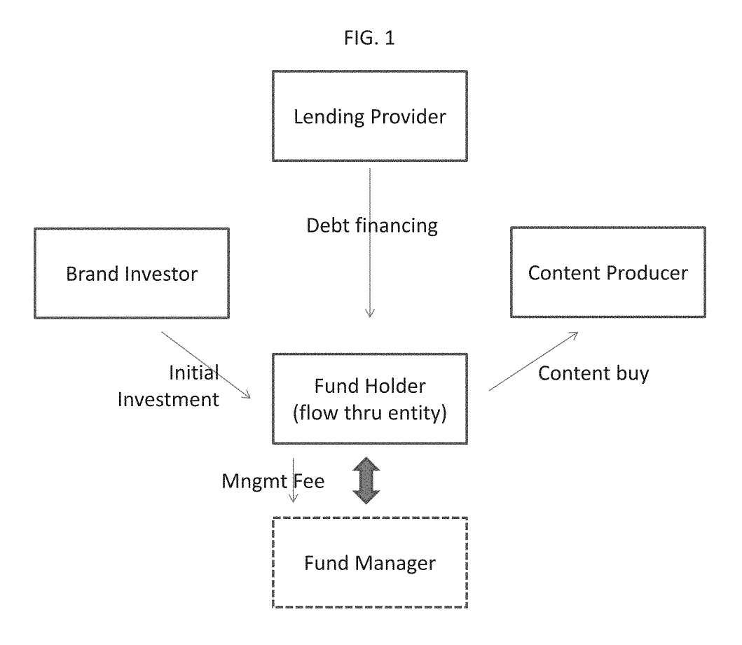

The present invention is directed to a method and system for implementing a multi-party financial transaction, such as but not limited to one related to an advertising purchase. In the context of the present invention, the purchase is a non-capital purchase which involves several parties, interrelated as shown in FIG. 1. Parties shown in solid lines are requisite to the invention and dotted-line parties are frequently included.

A goal of the present invention is to take advantage of the ability to leverage money. Each party's benefit is consequential, at least in part, to the time value of an investment.

In concept, an advertiser (“brand investor”) wishes to make a large-scale purchase of advertising at an event, where the event may span a period of time and/or a plurality of venues. The advertising is referred to herein as a “media buy” but is not limited to purchase of media advertising. The media buy may be a combination of one or more various forms of advertising such as but not limited to print or media ads and naming rights, among others, such that the brand investor is or becomes a sponsor of the event in exchange, at least in part, for advertising and/or promotional consideration.

The media buy could take any of several forms such as but not limited to direct advertisement in any of several forms, product placement, naming rights, etc.

The brand investor may be a publicly traded company.

The event is controlled by an entity (“content producer”).

The event could be, for example, a sports event or series, a film or series production, television production or advertising, games, digital/internet, music, or even a venue of facility, etc. Applicable further examples include a golf or tennis tournament or a series of such tournaments, a particular sports team, a Broadway show, a movie, naming rights, media time, paid advertising, or athlete endorsement.

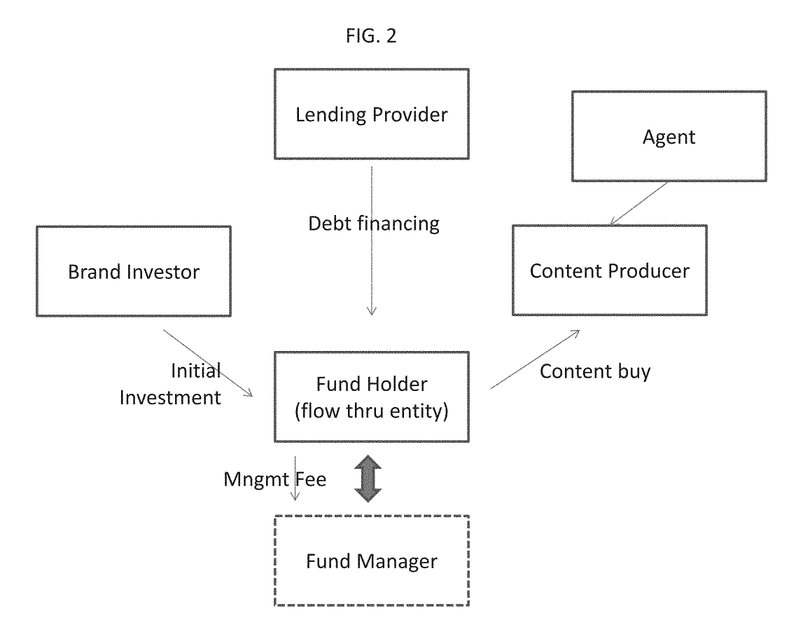

The advertising of the present invention is purchased by a brand investor and could be an aggregation buy, such as, for example, a single brand provider purchasing multiple media advertising (print, radio, and television, for example). The actual purchaser, however, could be an agent purchasing on behalf of a plurality of brands. For example, an agent may be serving a role as an overarching brand investor, representing multiple brand investors, and may be receiving payment from multiple brands (e.g., one beer, one soda, one tooth paste, and so on). FIG. 2 shows this revised example. In this case, the agent may be leveraging the time value of money on behalf of multiple inventors. In this scenario, the advertisement itself may take the form of a rotating display, such as a sign board or banner which rotates ads such that different ads appear at different times such that the advertising is effectively time-shared.

In summary, the present invention is directed to implementation, typically using a programmed computer to generate requisite documents and cash flow, of a funding scenario for an advertising buy by a brand investor from a content provider. The content provider is preferably the provider of an event or locale suitable for sponsorship. In a further example, an event could be, as described above, a sports event, and a locale could be, for example, a Government facility such as a transportation (e.g., airport) terminal, a subway line, a bridge, a tunnel, a road, a park, or a building. The locale could alternatively be a non-Governmental locale such as, for example, a stadium, an arena, a theater, a building.

In another scenario, the content provider could be delivering a sequence of events, such as a two week tennis tournament. In another scenario, the content provider could be providing a long term advertising play, such as naming rights for a stadium.

The present invention further includes a lending provider, such as a bank, in the preferred embodiment. In alternative embodiments, the lending provider can be something other than a bank but serving the same or similar function, such as an entity formed through crowdsourcing, where the funders receive a return, potentially including tangible product. That is, instead of obtaining debt financing from a bank, such financing can be achieved, at least in part, through crowdsource funding. In one scenario, the crowdsource funding may be directed to an entity named or established by at least one of the entities should in FIG. 2. In one scenario, a brand investor may be introducing a new product and crowdsource funders could receive some combination of a return on investment, product, and/or capital return.

The method of the present invention begins with an initial buy or investment from a brand investor, thereby demonstrating willingness to make a large advertising buy. This investment is a relatively small percentage of the actual purchase value and can be viewed as a down payment. A content producer, upon being presented with a contract for purchase, delivers indication of the willingness of the brand investor to make a large advertising buy by preparing and presenting a letter of credit (LOC or LC), which the brand investor takes to a lending provider and assumes responsibility for, thereby guaranteeing it to a lending provider. The LOC details the brand investor's purchase price and a notification provided by the content provider of the purchase. The lending provider, upon recognizing the initial investment plus the LOC, provides the remainder of the requisite purchase value as debt financing.

In the context of the present invention, all transactions may be disclosable so as to assure transparency of operation and cash flow.

Both the initial investment and the debt financing are delivered to a fund holder which holds and distributes funds. A fund manager, which may be separate from the fund holder, manages the entity, which itself is responsible for cash flow, potentially in exchange for a management fee or some other known form of compensation.

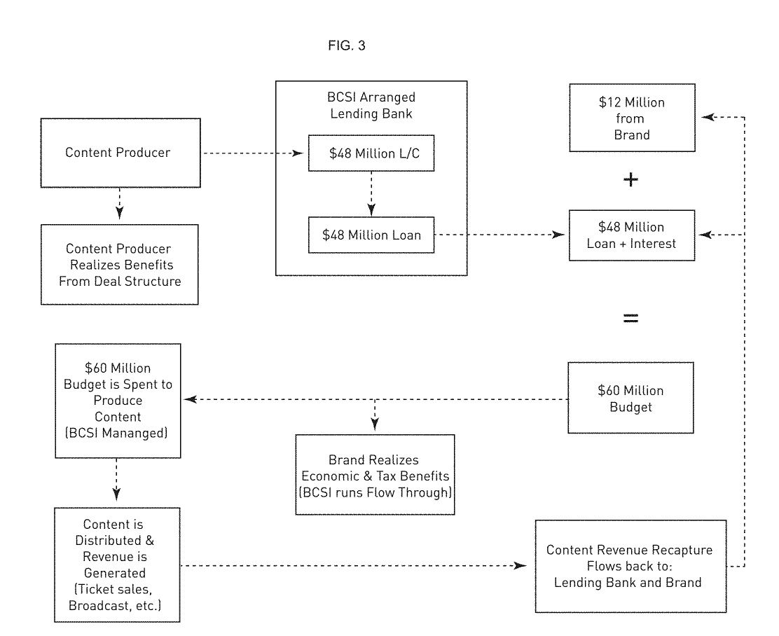

FIG. 3 shows a flow of cash in the present invention. The fund holder distributes money automatically based on several factors such as but not limited to:
Payment of interest on debt
Distribution of fees for advertising

The net result is that the content producer receives payment over time based on contract terms where the contract(s) is/are among the aforementioned parties. Brand investor only has limited out of pocket payments at start of engagement and therefore retains much of the overall fee over time to leverage the time value of the money. The brand investor also is afforded the opportunity to obtain an accelerated write off of the overall purchase (inclusive of the debt), as advertising is entitled to an accelerated tax write-off. In short, the brand investor enjoys the benefits of the larger purchase without an initial outlay of all the funds.

One further benefit to the present invention is that ability of the transaction to extend over time and allow for payment at favorable terms to all parties. In one example, an event, such as a stadium naming, can extend for many years and, consequently, payment can be made over the duration of the agreement at defined intervals. Similarly, debt financing can be provided in installments. In another example, some brand investors look to extend payment for several months. Such payments can be made in a more timely way by delaying out-of-pocket payments from the brand investor yet allowing more timely receipt by a content provider.

Fees to the fund manager (or retained by the fund holder) can be gathered in any number of ways including but not limited to a management fee, stock returned from the brand investor, or a return of some advertising fees from the content purchaser. Similarly, the content purchaser can return some funds as a credit to the brand investor or provide return compensation in any of several known ways such as but not limited to a form of profit sharing.

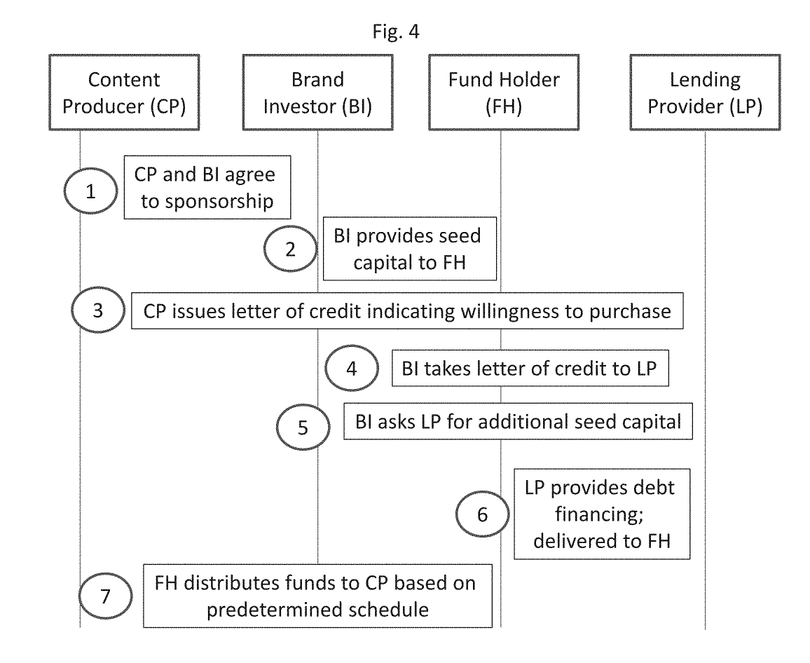

A representative series of steps is depicted in FIG. 4 and involves at least four parties
a content producer who is in or related to control of an event,
a brand investor, such as a publicly traded entity dealing in consumer goods,
a fund holder who controls distribution of funds and who may be associated with a related management company, and
a lending provider who provides debt financing related to the transaction.

In the method depicted in FIG. 4, each of the parties may separately have a processor which controls the various transactions and operations. The process begins with the brand investor agreeing to terms and conditions regarding sponsorship of an event, where an event is as described above. The agreement includes at least indication of value, duration, and payment schedule. A fund holder is identified and the brand investor delivers seed capital to the fund holder for safe keeping. In step 3, the content provider issues a letter of credit pursuant to the agreement and indicating a willingness to purchase a defined value of sponsorship. The letter is provided to the brand investor. In steps 4/5, the brand investor requests additional seed capital from one or more lending providers using the letter of credit to show demand for purchasing commensurate with a percentage of the total required seed capital and at least equivalent to the requested additional seed capital. The seed capital in total is provided to the fund holder. The fund holder is also provided with the agreed to payment schedule and the repayment schedule for the lending provider's contribution and is responsible as an independent third party to assure conformance to schedule and corresponding payments are timely made. The fund holder may have a related organization which manages some or all the process for a fee.

The present invention is implemented beginning with delivery of the letter of credit from the content producer to the brand investor, which the brand investor guarantees with the lending provider. The brand investor then implements a series of transactions automatically as follows:

The brand investor automatically prepares materials so as to establish the fund holder. The fund holder is an entity separate from the other entities and its ownership structure may be independent from the other entities or have some common ownership with one or more of the entities. Often, the fund holder may be an LLC or partnership.

Upon filing the requisite papers, the fund holder may be established as an entity, such as a corporation. Notification of the existence of the entity is provided to all other parties and the lending provider and the brand investor each deliver their requisite (per the contracts) shares of funding to the fund holder. The brand investor then orders buys of advertising (or other comparable purchase) from the content producer. Pursuant to the contract, the content producer bills the fund holder and, similarly, the lending provider bills the fund holder for debt service. All of these transactions happen automatically based on triggers (such as regularity of debt service).

Variations of the model described above are also available in the context of the present invention. For example, suppose there is an arrangement for a brand investor to finance a movie production in exchange for product placement and a share of profits of the movie (of course, the return to the brand investor can take any of several known forms, alone or in combination with one another, such as but not limited to reduction in fees, a cash return, or a share of subsequent profits). While described herein as pertaining to a movie production, this scenario is equally applicable to financing other entities, such as arena naming rights, a theatrical production, naming of a venue, a highway, etc. In this scenario, the brand investor contributes a percentage of the anticipated costs with the remainder borrowed from a lending provider and all funds delivered to a fund holder for distribution, just as described above.

However, suppose the movie production costs unexpectedly require exceeding the budget and therefore exceeding the arranged funding. One option is for the brand investor to put up additional cash and have the brand investor guarantee payment in a second letter of credit (where the letter indicates a guarantee based on, for example, an advance of the movie's ticket sales). The lending provider agrees to provide the remainder of the needed financing based on the delivered equity and LOC. The lending provider may be a second provider in this case. The brand investor may receive “above the line” earnings from the film under a so-called “waterfall payment schedule”. As before, the fund holder holds all funds until needed. Also, the return on investment (such as ticket sales in this scenario) can be delivered to the fund holder for re-distribution, and the fund manager can retain a management fee for its role.

Because of the unanticipated extra costs, the overall profit sharing arrangement could be adjusted. For example, the original profit sharing arrangement might have been that the brand investor receives X% of the profit but, subsequent to the second investment, the brand investor receives Y% of the profit, where Y>X.

Summary of funding model benefits:

Benefits to the brand investor
Limited outlay, tax benefit, possible reduced overall cost, delayed outlay
Tax benefits (delayed payments, write off of expense)
Possible payment through alternate means (e.g., stock)
Opportunity for “Near-term” Return on Advertising Expenditures
Leverage opportunity
Some or all management fees deferred until recoupment of expenditures
Loans repaid with first funds earned by Content exploitation
Tax advantaged expenditures (x:1 write-off, such as 5:1 in the example below)

Benefits to content producer—(may be co-beneficial with others)
Co-funding opportunity
Risk-sharing
Sizable sale with limited investment

A Sample Scenario: Brand Investor spends $60 million with Content Producer to co-promote a Sporting Event, Movie, or Concert.

An Example: How Fund Manager Adds Value to the Transaction:

Attachment 1 shows a multi-year scenario of the example described below.

Brand Investor agrees to spend $60 million with Content Producer, but Brand Investor wants 150 day terms, same as cash.

Fund Manager consults with Brand Investor and determines that Brand Investor banks at Lending Provider.

Fund Manager asks Content Producer for a Letter of Credit for $48 million against the Brand Investor media buy. This is a letter, not an actual credit line.

The fund holder is set up as a partnership or LLC (Fund Holder), solely owned by the Brand Investor, or in a co-ownership arrangement with Brand Investor, and the fund holder takes the LOC from Content Producer and $12 million in cash from Brand Investor to Lending Provider.

At Lending Provider, Brand Investor assumes the responsibility for the LOC and an account is set up with the $12 million in cash and $48 million from a loan against the LOC (now guaranteed by Brand Investor) and the Fund Holder is now funded with $60 million.

Content Producer starts promoting Content on behalf of Brand Investor and Content Producer immediately begins receiving payments for the media buy from Fund Holder.

Meanwhile, economic and tax opportunities are taking place at Brand Investor:

Brand Investor now has retained $48 million in cash—otherwise destined for the co-promotion spend—that can be used in several ways. One example of which is to allocate the funds to Capital Investment—depending on the Internal Rate of Return, this could be a windfall as much as 10%-40%.

Brand Investor, while only investing $12 million in cash, still can elect to write-off the entire Content Producer spend of $60 million (a 5:1 write-off)—in this scenario Brand Investor would achieve a $25 million tax benefit.

As Brand Investor books the revenue from the sales of the product or services that Content Producer co-promotes, it pays the interest on the loan against the LOC—giving Brand Investor a new way to correlate sales to advertising and promotional expenses. Or Brand Investor can payoff the loan and close out the deal at their discretion.

The sum of these economic and tax advantages are greater than the interest on the LOC at Lending Provider and the management fees collected by Fund Manager.

Fund Manager runs the LLC and keeps a set of audited books on the deal and intends to employ a nationally recognized public accounting firm to oversee the process.

Brand Investor will likely roll this over year after year, accruing a rolling and escalating tax advantage—and giving Content Producer stronger ties to the account.

### Results:

Content Producer books $60 million in revenue and gets paid immediately

Content Producer forges a stronger and longer relationship with Brand Investor

Brand Investor gets leverage

Brand Investor only spends $12 million in cash

Brand Investor receives a 5:1 tax opportunity: Brand Investor still writes off $60 in advertising expenses and gets $24 million in tax advantages

Brand Investor receives $60 million of co-promotional consideration

Brand Investor frees up $48 million in cash for Capital Investment

Brand Investor uses revenue derived from advertising to pay for advertising

Brand Investor windfalls more than cover: Lending Provider interest, Fund Manager fees

Brand Investor actually has potential to make money on its co-promotion spend

Lending Rationale.

The following description provides rationale for using the present invention.

Why should Brand X use the present invention vs. direct borrowing? Short term borrowing is common, yet ad spend problems persist and are growing. A particular brand (“BrandX”) has short term borrowing opportunities and has access to more. But problems associated with BrandX's media and sponsorship spending persist, which remain unsolved in the short term borrowing paradigm.

In the context of a $60 million deal example, if BrandX were to simply borrow an incremental $48 million for operating expenses it might potentially be able to achieve a leveraged tax position. Without a partner (“XYZ, LLC”) as described herein, BrandX is not borrowing against their ad budget, but instead, against the entire operating budget.

Most importantly, the ratio of short term borrowing to operating expenses extends influence over all aspects of BrandX's ability to borrow. A typical brand may have an ad budget which typically runs at 10-15% of its operating budget. Borrowing 80% of that amount would significantly challenge BrandX's short term credit worthiness.

Long term (capital) borrowing is also problematic. In this example, if BrandX were to finance $48 million with long term borrowing and then invest $48 million as a capital investment, all BrandX achieves is only that and no further benefit, From this position, it's not possible to create leverage in the operating budget.

The model, as described herein results in:
Creates the opportunity for the 5:1 tax write off for BrandX
Creates actual leverage in BrandXs ad spend
Protects BrandX's short term borrowing obligations (When XYZ LLC is consolidated back onto BrandX's balance sheet, the debt would be apportioned to long term borrowing, as the $48 million freed up was allocated to capital investment and the loan was guaranteed by capital assets).

Aircraft leasebacks are commonly arranged and managed by independent third parties. The role of BCSI parallels this relationship. In the same way a hotel corporation might use a leaseback structure to recoup investments in real estate, or in the way an airline arranges leaseback of new aircraft, this deal structure allows BrandX to sell off its media buying costs and use leverage to reap economic benefits that outperform the cost of the sale.

1. A method for a processor to control transactions pursuant to an agreement for a brand investor party's sponsorship of an event comprising the steps of:
upon agreement between a brand investor party and a content producer for said brand investor to sponsor content, said processor directs transfer of seed capital from said party's account to a fund holder account with further instruction to operate per said agreement;
said processor receiving indication of seed capital being delivered from said party's account to said fund holder's account and being received;
said processor generating and delivering to a lending provider a letter of credit and an indication of delivered seed capital;
receiving indication from said lending provider of additional capital delivered to said fund holder; and
upon determined compliance with said agreement, said party authorizing said fund holder to deliver payments to said content producer.

2. The method of claim 1, where said payments are delivered in installments.

3. The method of claim 1, where said letter of credit is generated by said content producer.

4. The method of claim 1, where, upon a first payment to said content producer, said event is rebranded in favor of said party.

5. The method of claim 1, wherein where said additional capital is treated as debt financing and the terms of such financing are acted upon by said fund holder.

6. A method for a processor in control of a content producer to deliver event sponsorship to an investor pursuant to an agreement between said content producer and said investor, comprising the steps of:
upon agreement between a brand investor and a content producer for the brand investor to sponsor said event, said content provider arranges with said brand investor to establish a fund account, said account controlled based on said agreement;
said content provider receives indication that said brand investor delivers seed capital to said fund with instruction to operate per said agreement;
said processor issues a letter of credit and an indication of delivered seed capital to a lending provider;
said processor receives indication from a validated third party that additional capital was delivered from said lending provider to said fund account;
upon determined compliance with said agreement, delivering authorization to deliver payments from said fund to said content producer; and
adjusting sponsorship of said event per said agreement.

7. The method of claim 6, where said payments are delivered in installments.

8. The method of claim 6, where upon a first payment to said content producer, said event is rebranded in favor of said party.

9. The method of claim 6, wherein where said additional capital is treated as debt financing and the terms of such financing are acted upon by said fund holder.

10. A distributed system for managing a sponsorship agreement comprising:
a first processor for managing a content provider's actions;
a second processor for managing an investor's actions; and
a third processor for managing a fund holder's actions;
wherein upon agreement between an investor and a content producer for said investor to sponsor content, said second processor directs transfer of seed capital from said investor's account to a fund holder account with further instruction to operate per said agreement;
said first processor receiving indication of seed capital being delivered from said party's account to said fund holder's account and being received;
said first processor generating and delivering to a lending provider a letter of credit and an indication of delivered seed capital;
said third processor receiving indication from said lending provider of additional capital delivered to said fund holder; and
upon determined compliance with said agreement, said first processor and said second processor each authorizes said third processor to deliver payments to an account associated with said first processor.

11. The system of claim 10 where said payments are delivered in installments.

12. The system of claim 10 where, upon a first payment to said content producer, said event is rebranded in favor of said party.
